(19) United States
(12) Patent Application Publication
(10) Pub. No.: US 2025/0038312 A1
(43) Pub. Date: Jan. 30, 2025

(54) METAL-AQUEOUS BATTERY AND HYDROGEN GENERATION AND CARBON DIOXIDE STORAGE SYSTEM INCLUDING SAME

(71) Applicants: Hyundai Motor Company, Seoul (KR); Kia Corporation, Seoul (KR); UIF (University Industry Foundation), Yonsei University, Seoul (KR)

(72) Inventors: Yun Su Lee, Uiwang (KR); Ji Hoon Jang, Suwon (KR); Shin Tae Bae, Incheon (KR); Dongil Lee, Goyang (KR); Yongsung Jo, Seoul (KR); Eunsaem Park, Daejeon (KR)

(21) Appl. No.: 18/530,899

(22) Filed: Dec. 6, 2023

(30) Foreign Application Priority Data
Jul. 24, 2023 (KR) 10-2023-0096118

(51) Int. Cl. H01M 10/26; H01M 4/24; H01M 10/28; H01M 50/46; H01M 50/627

(52) U.S. Cl. CPC H01M 12/04; H01M 4/38; H01M 4/381; H01M 4/382; H01M 4/925; H01M 50/414; H01M 50/471; H01M 50/50; H01M 50/627; H01M 50/682; H01M 50/426; H01M 2300/0002; H01M 2300/0014; H01M 2300/002

(57) ABSTRACT

Provided are a metal-aqueous battery and a hydrogen generation and carbon dioxide storage system including the same. The metal-aqueous battery may include a double cell. The double cell may include a pair of single cells. Each of the single cells include an anode, a cathode, a separator interposed between the anode and the cathode, and a cathode spacer interposed between the separator and the cathode and configured to form a gap between the separator and the cathode. The double cell may also include a current collector interposed between the pair of single cells such that cathodes of the single cells face each other across the current collector.

### CROSS-REFERENCE TO RELATED APPLICATION

This application claims, under 35 U.S.C. § 119(a), the benefit of Korean Patent Application No. 10-2023-0096118, filed on Jul. 24, 2023, the entire contents of which are incorporated herein by reference.

### BACKGROUND

### Technical Field

The present disclosure relates to a metal-aqueous battery and a hydrogen generation and carbon dioxide storage system including the same.

### Background

Recently, thorough research into electrochemical water electrolysis is ongoing in line with the development of renewable energy to respond to climate change. Moreover, importance of technology for capturing, storing, and converting carbon dioxide (CO₂) for greenhouse gas reduction is growing.

Zinc/aluminum (Zn/Al)-based aqueous battery systems use very economical candidates for metal anodes in view of price and reserves. A zinc/aluminum (Zn/Al) based aqueous battery system is a system that produces hydrogen and simultaneously captures carbon dioxide in the form of a salt such as KHCO₃, etc.

However, since a conventional metal-aqueous battery is a single cell composed of one anode and one cathode and a stack based thereon, the current obtainable therefrom is limited.

### SUMMARY OF THE DISCLOSURE

An object of the present disclosure is to provide a metal-aqueous battery with improved current generation amount and current generation rate.

An object of the present disclosure is to provide a metal-aqueous battery capable of preventing an anode from being passivated.

The objects of the present disclosure are not limited to the foregoing. The objects of the present disclosure will be able to be clearly understood through the following description and to be realized by the means described in the claims and combinations thereof.

In one aspect, a metal-aqueous battery is provided, the battery comprising: a) a double cell comprising: i) a pair of single cells, each of the single cells comprising: an anode, and a cathode, and ii) a separator interposed between the anode and the cathode, and b) a cathode spacer interposed between the separator and the cathode and configured to form a gap between the separator and the cathode; and c) a current collector interposed between the pair of single cells such that cathodes of the single cells face each other across the current collector.

An exemplary embodiment of the present disclosure provides a metal-aqueous battery, including a double cell configured such that a current collector is interposed between a pair of single cells each including an anode, a cathode, and a separator interposed between the anode and the cathode so that the cathodes of the single cells face each other across the current collector, in which each of the single cells may include a cathode spacer interposed between the separator and the cathode and configured to form a gap between the separator and the cathode.

Each of the single cells may further include a plate in a sheet form at a predetermined thickness including a first main surface and a second main surface facing the first main surface, disposed on an outer surface of the single cell, and having an inner space open toward the first main surface,

The anode may be accommodated in the inner space.

The separator may be stacked on the first main surface to cover an open surface of the inner space.

The plate may include a first electrolyte inlet formed in a portion of a side surface and configured to communicate with the inner space and a first electrolyte outlet formed at a position spaced apart from the first electrolyte inlet by a predetermined distance and configured to communicate with the inner space.

The anode may be in the form of a pellet, each of the single cells may further include a support that is obliquely provided in the inner space and includes a plurality of through-holes, the anode may be accommodated between the inner surface of the plate and the support, and a diameter of the through-holes may be smaller than a diameter of the anode.

The anode may be in the form of a sheet, and each of the single cells may further include a pressing part that is accommodated in the inner space and is provided between the inner surface of the plate and the anode to apply a pressing force to move the anode toward the separator.

The anode may include at least one selected from the group consisting of lithium (Li), sodium (Na), magnesium (Mg), zinc (Zn), aluminum (Al), and a combination thereof.

The metal-aqueous battery may further include a wire configured to electrically connect the anode and the current collector to each other.

The cathode may include a noble metal catalyst loaded on a carrier.

The metal-aqueous battery may further include a separator spacer interposed between the plate and the separator, having a predetermined thickness, and having a frame shape, a central portion of which is open, in which the separator spacer may support an edge of the separator to expand the inner space of the plate by a thickness of the separator spacer.

The metal-aqueous battery may further include a protective layer, which has a shape corresponding to the open surface of the plate, is provided to the open surface of the plate, and is porous.

The separator may include a material having cation conductivity or a material having anion conductivity.

The cathode spacer may have a frame shape, a central portion of which is open, and may support an edge of the separator to form the gap, and the cathode spacer may include a second electrolyte inlet formed in a portion of a side surface of the cathode spacer and configured to communicate with the gap and a second electrolyte outlet formed in a portion of a side surface of the cathode spacer spaced apart from the second electrolyte inlet by a predetermined distance and configured to communicate with the gap.

The metal-aqueous battery may further include a first electrolyte accommodated in the inner space of the plate, and a second electrolyte accommodated in the gap.

The first electrolyte may include an alkali metal hydride.

The second electrolyte may include protons and bicarbonate ions.

The temperature of the first electrolyte may be about 40° C. to about 80° C.

The temperature of the second electrolyte may be about 40° C. to about 80° C.

The temperature of the first electrolyte may be equal to or higher than the temperature of the second electrolyte.

The metal-aqueous battery may include a stack configured such that a plurality of double cells is stacked.

Another embodiment of the present disclosure provides a hydrogen generation and carbon dioxide storage system, including the metal-aqueous battery described above, a first electrolyte supply unit configured to supply a first electrolyte to the metal-aqueous battery, a second electrolyte supply unit configured to supply a second electrolyte to the metal-aqueous battery, a first heating apparatus disposed between the metal-aqueous battery and the first electrolyte supply unit, and a second heating apparatus disposed between the metal-aqueous battery and the second electrolyte supply unit.

The first heating unit suitably may include a first heat exchanger configured to exchange heat between the first electrolyte and a heat source, and the second heating means may include a second heat exchanger configured to exchange heat between the second electrolyte and a heat source.

### BRIEF DESCRIPTION OF THE DRAWINGS

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1 shows a first embodiment of a metal-aqueous battery according to the present disclosure;

FIG. 2 shows electrolyte flow of the metal-aqueous battery according to the present disclosure;

FIG. 3 shows a plate according to the present disclosure;

FIG. 4A shows a first embodiment of a support according to the present disclosure;

FIG. 4B shows a second embodiment of the support according to the present disclosure;

FIG. 4C shows a third embodiment of the support according to the present disclosure;

FIG. 5 shows a second embodiment of the metal-aqueous battery according to the present disclosure;

FIG. 6 shows a cathode spacer according to the present disclosure;

FIG. 7 shows a stack according to the present disclosure;

FIG. 8 shows a hydrogen generation and carbon dioxide storage system according to the present disclosure;

FIG. 9 shows a discharge graph of a metal-aqueous battery having a double cell DC structure and a metal-aqueous battery having a single cell SC structure in Test Example 1;

FIG. 10 shows a discharge graph depending on the current density of the metal-aqueous battery at different temperatures of the first electrolyte in Test Example 2;

FIG. 11 shows a discharge graph with time of the metal-aqueous battery at different temperatures of the first electrolyte in Test Example 2;

FIG. 12 shows results of evaluation of the metal-aqueous battery at different temperatures of the second electrolyte in Test Example 3; and

FIG. 13 shows a discharge graph of the metal-aqueous battery under Conditions 1 to 3 in Test Example 4.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element.

Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

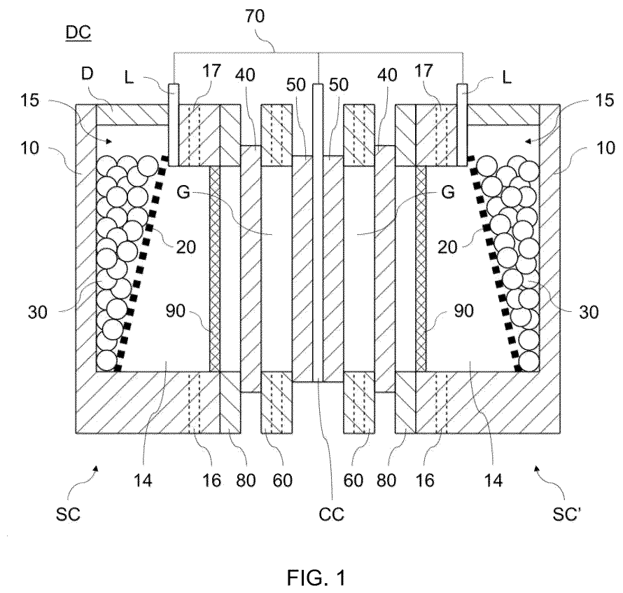

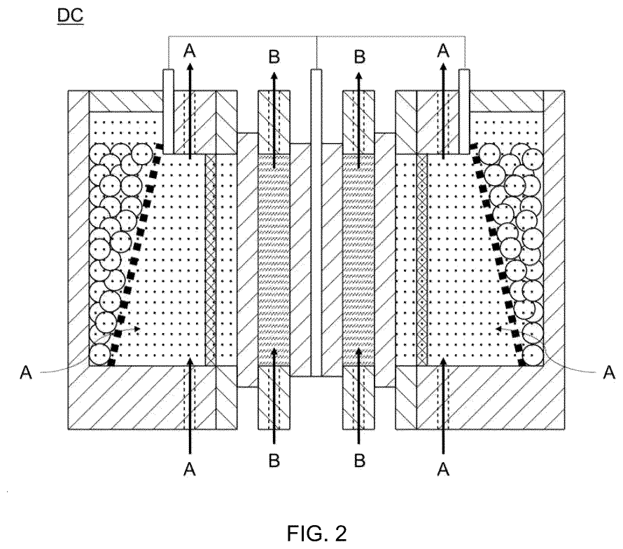

FIG. 1 shows a first embodiment of a metal-aqueous battery according to the present disclosure. For convenience of description and understanding, a first electrolyte A and a second electrolyte B are not shown in FIG. 1. FIG. 2 shows the electrolyte flow of the metal-aqueous battery according to the present disclosure.

The metal-aqueous battery may include a double cell DC configured such that a current collector CC is interposed between a pair of single cells SC each including an anode 30, a cathode 50, and a separator 40 interposed between the anode 30 and the cathode 50 so that the cathodes 50 of the single cells face each other.

The current collector CC may be made of an electrically conductive material. For example, the current collector CC may be obtained by plating a thin sheet of stainless steel with gold (Au).

With reference to FIGS. 1 and 2, each single cell SC may include a plate 10, a sheet-type support 20 provided in an inner space 14 of the plate 10, an anode 30 accommodated between the plate 10 and the support 20, a separator 40 stacked on the plate 10, a first electrolyte A accommodated in the inner space 14 of the plate 10, a cathode 50 disposed on the separator 40, a cathode spacer 60 interposed between the separator 40 and the cathode 50 and configured to form a gap G between the separator 40 and the cathode 50, and a second electrolyte B accommodated in the gap G.

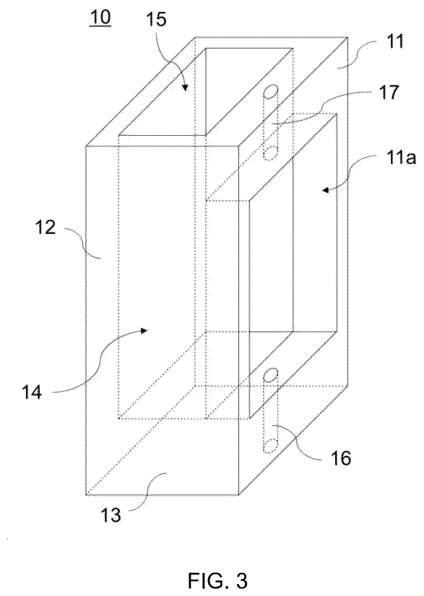

FIG. 3 shows the plate 10. The plate 10 may be in the form of a sheet having a predetermined thickness including a first main surface 11, a second main surface 12 facing the first main surface 11, and side surfaces 13 connecting the first main surface 11 and the second main surface 12.

The plate 10 may be made of a material having superior physical properties without electrical conductivity. For example, the plate 10 may be made of polycarbonate.

The plate 10 may include an inner space 14 open toward the first main surface 11. The inner space 14 open toward the first main surface 11 means that a portion of the first main surface 11 is opened to form an open surface 11a so that the inner space 14 communicates with the outside.

The plate 10 may include an opening 15 formed in a portion of the side surface 13 to allow the inner space 14 to communicate with the outside. For example, an opening 15 may be present in a portion of the upper side of the plate 10 as shown in FIG. 1. The anode 30 may be supplied to the inner space 14 through the opening 15.

The metal-aqueous battery may further include a stopper D removably attached to the opening 15. The size of the stopper D is not particularly limited, so long as the stopper is able to completely block the opening 15 to prevent the inner space 14 from contacting the outside. Also, the stopper D may be made of a material that is not reactive with the first electrolyte A and the anode 30.

The plate 10 may include a first electrolyte inlet 16 formed through a portion of the side surface 13 and configured to communicate with the inner space 14 and a first electrolyte outlet 17 formed through a portion of the side surface spaced apart from the first electrolyte inlet 16 by a predetermined distance and configured to communicate with the inner space 14. For example, as shown in FIG. 1, the first electrolyte inlet 16 may be present in the lower side surface 13 and the first electrolyte outlet 17 may be present in the upper side surface 13. Also, the plate 10 may include a plurality of first electrolyte inlets 16 and a plurality of first electrolyte outlets 17.

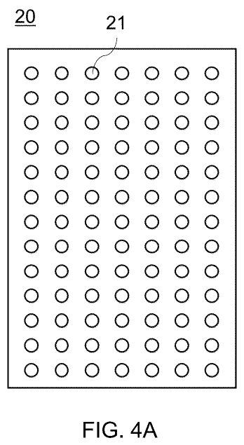

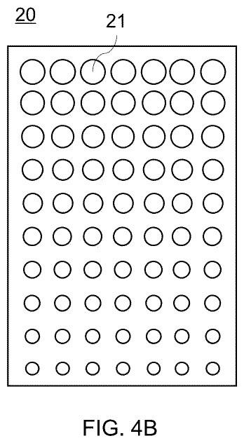

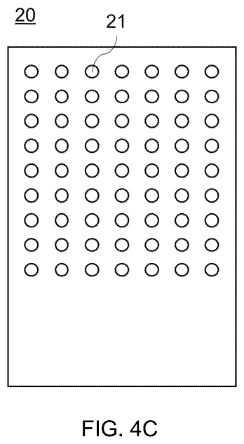

FIG. 4A shows a first embodiment of the support 20. As shown in FIG. 1, the support 20 may be obliquely provided so that the space in which the anode 30 is accommodated becomes narrower downward. When the anode 30 is decreased in size by ionization, it accumulates at the lower position. Accordingly, the contact area between the anode 30 and the support 20 is widened so that ionization of the anode 30 may occur more easily. When the contact area between the anode 30 and the support 20 is widened, the ionization area may increase, and thus the current density of the battery may increase.

The support 20 may include an electrically conductive metal. Also, the support 20 may include a material having rigidity capable of withstanding the weight of the anode 30. For example, the support 20 may include a stainless steel mesh.

The metal-aqueous battery may include a wire 70 configured to electrically connect the support 20 and the current collector CC to each other. The configuration for electrical connection is not particularly limited. For example, a lead L may be attached to the inner surface of the opening 15 of the plate 10 so that one end thereof is exposed outside, and one end of the support 20 may be provided to contact the lead L, after which a wire 70 may be connected to one end of the lead L.

The support 20 may include a plurality of through-holes 21. The first electrolyte A may move via the through-holes 21.

Since the support 20 has to prevent the anode 30 from leaving the space between the plate 10 and the support 20, the diameter of the through-holes 21 may be smaller than that of the anode 30. Specifically, the diameter of the through-holes 21 may be 0.5 mm to 2 mm.

FIG. 4B shows a second embodiment of the support 20. In a preferred embodiment, the support 20 is configured such that the diameter of the through-holes 21 decreases downward. This is because the anode 30, which is decreased in size during reaction and moves downward, is prevented from passing through the through-holes 21.

FIG. 4C shows a third embodiment of the support 20. The lower side of the support 20 may not have through-holes 21. Thereby, reaction may be quickly induced by increasing the contact surface of the anode, which is decreased in size during reaction, with the support at the lower side.

The anode 30 may be made of any material capable of generating electrons by being ionized in the first electrolyte, and for example, may include at least one selected from the group consisting of lithium (Li), sodium (Na), magnesium (Mg), zinc (Zn), aluminum (Al), and combinations thereof. Preferably, the anode 30 includes at least one selected from the group consisting of magnesium (Mg), zinc (Zn), aluminum (Al), and combinations thereof. Magnesium (Mg), zinc (Zn), and aluminum (Al) are stable in water and are preferred in aqueous systems. More preferably, the anode 30 includes at least one selected from the group consisting of zinc (Zn), aluminum (Al), and combinations thereof. Zinc (Zn) and aluminum (Al) are very desirable in consideration of world reserves and prices.

The anode 30 may be in the form of a pellet with a spherical shape, an elliptical shape, a cylindrical shape, etc. When the anode 30 has an elliptical shape, the diameter thereof is the length of a major axis. When the anode 30 has a cylindrical shape, the diameter thereof is the diameter of the base side. The diameter of the anode 30 may be 3 mm to 10 mm. If the diameter of the anode 30 is less than 3 mm, it may pass through the through-holes 21 due to the size decreased by ionization. On the other hand, if the diameter of the anode 30 exceeds 10 mm, the specific surface area of the anode 30 may decrease, and thus performance of the metal-aqueous battery may deteriorate.

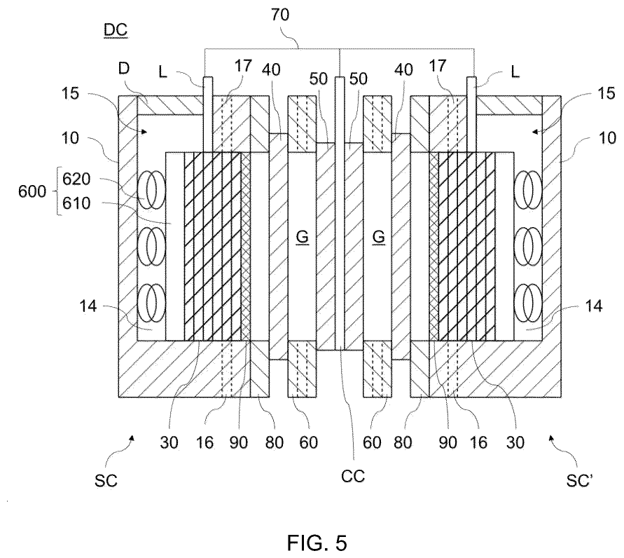

FIG. 5 shows a second embodiment of the metal-aqueous battery according to the present disclosure. Unlike FIG. 1, in FIG. 5, the anode 30 may be in the form of a sheet.

The metal-aqueous battery may include a pressing part 600 that is accommodated in the inner space 14 of the plate 10 and is provided between the inner surface of the plate 10 and the anode 30 to apply a pressing force to move the anode 30 toward the separator 40.

Here, the anode 30 may be configured such that a plurality of sheets is stacked and accommodated between the pressing part 600 and the separator 40.

The pressing part 600 may press the anode 30 toward the separator 40, so that those close to the separator 40 among the sheets of the anode 30 may be reacted and consumed first.

The pressing part 600 may include a support plate 610 configured to press the anode 30 and an elastic member 620 provided between the support plate 610 and the plate 10 to apply elastic force to the support plate 610.

When those close to the separator 40 among the sheets of the anode 30 are consumed by reaction, the support plate 610 presses the anode 30 by the elastic force of the elastic member 620. Thus, the anode 30 may be positioned close to the separator 40.

The metal-aqueous battery may further include a separator spacer 80 interposed between the plate 10 and the separator 40, with a predetermined thickness and a frame shape, a central portion of which is open.

The separator spacer 80 may support an edge of the separator 40 to expand the inner space 14 of the plate 10 by the thickness of the separator spacer 80. The thickness of the separator spacer 80 is not particularly limited, but may be 5 mm to 20 mm.

The metal-aqueous battery may further include a protective layer 90 having a shape corresponding to the open surface 11a of the plate 10 and provided to the open surface 11a of the plate 10.

The protective layer 90 may be made of a material having superior chemical resistance, such as rubber, resin, silicone, metal, etc.

The protective layer 90 may be porous. Accordingly, the protective layer 90 may be impregnated with the first electrolyte, so that potassium ions (K⁺) or sodium ions (Na⁺) in the first electrolyte may move to the separator 40.

The protective layer 90 may prevent the separator 40 from sagging. The protective layer 90 may serve as a physical support for the separator 40.

The separator 40 may include a material having cation conductivity. For example, the separator 40 may include a perfluorosulfonic acid-based resin such as Nafion, etc. Therefore, the separator 40 may block the movement of the first electrolyte A and the second electrolyte B while allowing the movement of cations between the anode 30 and the cathode 50.

The separator 40 may include a material having anion conductivity. For example, the separator 40 may include at least one selected from the group consisting of poly(terphenylene), 1,4-diazabicyclo[2,2,2]octane-poly(ether sulfone), poly(aryl piperidinium), poly(phenylene oxide)-block-poly(vinyl benzyl trimethyl ammonium), and combinations thereof. Accordingly, the separator 40 may block the movement of the first electrolyte A and the second electrolyte B while allowing the movement of anions between the anode 30 and the cathode 50.

The thickness of the separator 40 is not particularly limited, and may be, for example, 25 μm to 250 μm.

An area of the separator 40 may be larger than an area of the open surface 11a of the plate 10. Also, the separator 40 may cover the entire open surface 11a, and thus the first electrolyte A may be prevented from leaking.

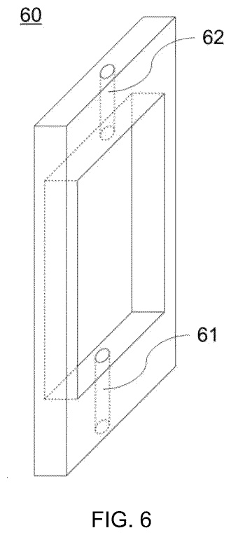

FIG. 6 shows a cathode spacer 60. The cathode spacer 60 may be interposed between the separator 40 and the cathode 50. The cathode spacer 60 has a frame shape, a central portion of which is open, and may support an edge of the separator 40 to thus form a gap G between the separator 40 and the cathode 50. The cathode spacer 60 may have a thickness of 5 mm to 20 mm.

The cathode spacer 60 may include a material that does not react with the second electrolyte B and has chemical resistance. For example, the cathode spacer 60 may include polycarbonate.

The cathode spacer 60 may include a second electrolyte inlet 61 formed through a portion of the side surface of the cathode spacer 60 and configured to communicate with the gap G and a second electrolyte outlet 62 formed through a portion of the side surface of the cathode spacer 60 spaced apart from the second electrolyte inlet 61 by a predetermined distance and configured to communicate with the gap G. For example, as shown in FIG. 6, the second electrolyte inlet 61 may be present in the lower side surface, and the second electrolyte outlet 62 may be present in the upper side surface. Also, the cathode spacer 60 may include a plurality of second electrolyte inlets 61 and a plurality of second electrolyte outlets 62.

The cathode 50 may include a noble metal catalyst loaded on a carrier. The type of carrier is not particularly limited, and may include, for example, at least one selected from the group consisting of carbon paper, carbon fiber, carbon felt, carbon black, carbon cloth, metal foam, metal thin film, and combinations thereof. The type of noble metal catalyst is not particularly limited, and may include, for example, platinum (Pt).

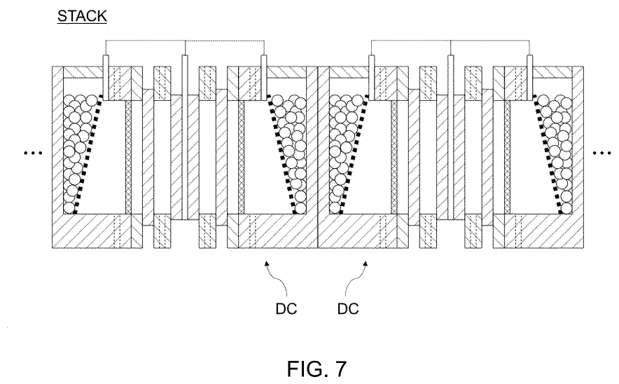

As shown in FIG. 7, the metal-aqueous battery may include a stack configured such that a plurality of double cells DC is stacked. The number of double cells DC that are stacked is not particularly limited and may be appropriately adjusted depending on a desired amount of current that is generated.

The present disclosure is characterized in that passivation of the anode 30 is prevented by increasing the temperature of the first electrolyte A and the second electrolyte B in the metal-aqueous battery and the current generation rate is increased.

The pH values of the first electrolyte A and the second electrolyte B may be as follows.
First electrolyte A: pH 14 or higher
Second electrolyte B: PH 7 to 9

Reaction may occur sufficiently when the pH values of the first electrolyte A and the second electrolyte B fall within the above ranges.

The first electrolyte A may include an alkali metal hydroxide. Preferably, the first electrolyte A includes at least one selected from the group consisting of potassium hydroxide (KOH), sodium hydroxide (NaOH), and combinations thereof. The concentration of the first electrolyte A may be 3 M to 6 M. When the concentration of the first electrolyte A is 6 M, a saturated solution of potassium ions (K⁺) or sodium ions (Na⁺) may be formed, whereas ionization of metal may not be sufficient at less than 3 M, and thus the appropriate concentration of the first electrolyte A may be 3 M to 6 M.

The temperature of the first electrolyte A may be about 40° C. to about 80° C. If the temperature of the first electrolyte A is lower than about 40° C., it may be difficult to obtain an effect of preventing passivation of the anode 30.

The second electrolyte B may include protons and bicarbonate ions. Preferably, the second electrolyte B includes at least one selected from the group consisting of potassium bicarbonate (KHCO₃), sodium bicarbonate (NaHCO₃), and combinations thereof.

Materials supplied from a second electrolyte supply unit 300, which will be described later, may be used without limitation, so long as they satisfy pH 7 to 9 in the cell (gap: G) due to dissolution of carbon dioxide (CO₂) and contain protons and bicarbonate ions. Examples thereof may include potassium hydroxide, potassium carbonate, potassium bicarbonate, sodium hydroxide, sodium carbonate, and sodium bicarbonate.

The concentration of the second electrolyte B may be 0.5 M to 3 M. If the concentration of the second electrolyte B is less than 0.5 M, it may affect the reaction rate depending on an increase in pH, and a saturated solution of potassium ions (K⁺) or sodium ions (Na⁺) may be formed at 3 M, and thus the above concentration range may be appropriate.

The temperature of the second electrolyte B may be about 40° C. to about 80° C. When the temperature of the second electrolyte B falls within the above numerical range, resistance in the metal-aqueous battery may be lowered and overvoltage may be prevented from occurring.

The first electrolyte A and the second electrolyte B may be heated in advance to temperatures within the above numerical ranges and then supplied to the metal-aqueous battery. Preferably, the temperature of the first electrolyte A is equal to or higher than the temperature of the second electrolyte B. Since increasing the activation of the anode 30 is important in the overall reaction, the temperature of the first electrolyte A may be regarded as more important. Taking into consideration the overall reaction, therefore, it is preferred that the temperature of the first electrolyte A be equal to or higher than the temperature of the second electrolyte B.

The temperature of the first electrolyte A and the second electrolyte B may be increased by providing a heater outside the metal-aqueous battery, or using a first heating apparatus or means 400 and a second heating apparatus or means 500, as will be described later. A preferred method of controlling the temperature of the first electrolyte A and the second electrolyte B is described below.

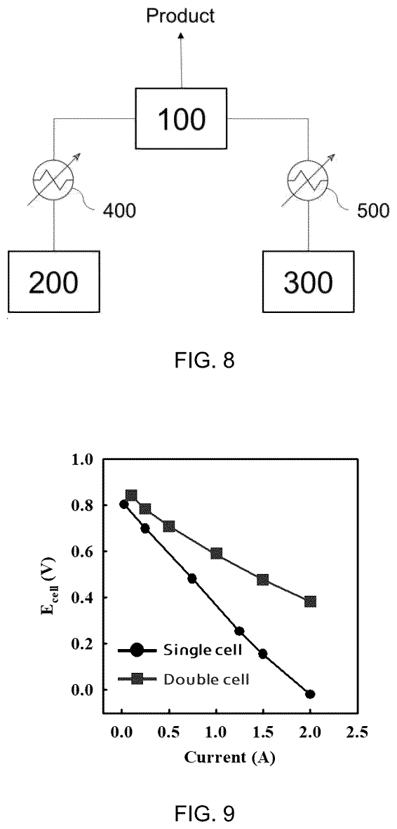

FIG. 8 shows a hydrogen generation and carbon dioxide storage system according to the present disclosure. The system includes the metal-aqueous battery 100 described above, a first electrolyte supply unit 200 configured to supply a first electrolyte to the metal-aqueous battery 100, a second electrolyte supply unit 300 configured to supply a second electrolyte to the metal-aqueous battery 100, a first heating apparatus 400 disposed between the metal-aqueous battery 100 and the first electrolyte supply unit 200 and configured to perform heat exchange between the first electrolyte and a heat source, and a second heating apparatus 500 disposed between the metal-aqueous battery 100 and the second electrolyte supply unit 300 and configured to perform heat exchange between the second electrolyte and the heat source.

The temperature of the first electrolyte may be increased by allowing heat of the heat source to be transferred to the first electrolyte in the first heating apparatus 400. Also, the temperature of the second electrolyte may be increased by allowing heat of the heat source to be transferred to the second electrolyte in the second heating means 500. The first heating apparatus 400 and the second heating apparatus 500 may be exemplified by a heat exchanger, but are not limited thereto.

The type of heat source is not particularly limited, and may include, for example, exhaust gas, waste heat water, and the like from power plants, vehicles, landfills, etc.

The mode of operation of the system is described below with reference to FIGS. 1, 2, and 8.

The first electrolyte supply unit 200 may supply the first electrolyte A to the metal-aqueous battery 100 through the first electrolyte inlet 16. Here, the first electrolyte A is heated to about 40° C. to about 80° C. by receiving heat from a heat source in the first heating apparatus 400.

The first electrolyte A may be supplied into the inner space 14 of the plate 10 through the first electrolyte inlet 16.

When the anode 30 contacts the first electrolyte A, the anode 30 may be ionized to thus generate electrons. The electrons move to the current collector CC along the support 20, the lead L, and the wire 70, and then are transferred to the cathode 50.

Alkali metal ions, preferably potassium ions (K⁺) or sodium ions (Na⁺), generated during ionization of the anode 30, may move to the cathode 50 through the separator 40.

The second electrolyte supply unit 300 may supply the second electrolyte B and carbon dioxide to the metal-aqueous battery 100 through the second electrolyte inlet 61. Here, the second electrolyte B is heated to 40° C. to 80° C. by receiving heat from the heat source in the second heating apparatus 500. The system may further include a carbon dioxide supplier (not shown) configured to supply carbon dioxide to the second electrolyte supply unit 300. Alternatively, the second electrolyte supply unit 600 may serve to supply an electrolyte in which carbon dioxide is dissolved.

The second electrolyte B and carbon dioxide may be supplied to the cathode 50 through the second electrolyte inlet 61. At the cathode 50, the following chemical dissolution reaction of carbon dioxide occurs.

CO₂ (g)+H₂O (l)→H⁺ (aq)+HCO₃⁻ (aq)

Thereafter, the following hydrogen generation reaction occurs at the cathode 50.

2H⁺ (aq)+2e⁻→H₂ (g)

Also, at the cathode 50, carbon dioxide is stored in the form of a salt as follows.

HCO₃⁻ (aq)+K⁺ (aq)→KHCO₃ (g)

HCO₃⁻ (aq)+Na⁺ (aq)→NaHCO₃ (g)

Here, H₂ and KHCO₃ (or NaHCO₃) are discharged to the outside of the battery through the second electrolyte outlet 62 together with the second electrolyte.

A better understanding of the present disclosure may be obtained through the following test examples. These test examples are merely set forth to illustrate the present disclosure, and are not to be construed as limiting the scope of the present disclosure.

### TEST EXAMPLE 1

Cell performance was evaluated by operation of a double cell DC as shown in FIG. 1. In addition, a metal-aqueous battery having a single cell SC structure was prepared and cell performance thereof was also evaluated.

FIG. 9 shows a discharge graph of a metal-aqueous battery having a double cell DC structure and a metal-aqueous battery having a single cell SC structure. The metal-aqueous battery having a double cell DC structure exhibits high cell potential at the same current, indicating that the metal-aqueous battery having a double cell DC structure according to the present disclosure is capable of stably obtaining higher current.

The metal-aqueous battery having a double cell DC structure may be manufactured in a more compact cell by eliminating and reducing the size of components in the cathode manifold, current collector, and wire compared to a metal-aqueous battery having a plurality of single cell SC structures. Moreover, as compared to controlling a plurality of single cells SC individually, the use of the double cell DC is capable of halving the number of control factors.

### TEST EXAMPLE 2

The metal-aqueous battery having a double cell DC structure as shown in FIG. 1 operated at different temperatures of the first electrolyte, such as 20° C., 40° C., 60° C., and 80° C. ZUR (zinc utilization ratio) of the metal-aqueous battery is shown in Table 1 below. The ZUR value was calculated by the following equation.

$$Z U R ( Zinc Utilization Ratio ) = \frac{specific capacity of Zn}{Theoretical capacity of Zn}$$

TABLE 1

| Temperature | 20° C. | 40° C. | 60° C. | 80° C. |
|---|---|---|---|---|
| ZUR [%] | 25.56 | 51.89 | 83.60 | 87.50 |

When the temperature of the first electrolyte is 20° C., the ZUR value is about 25%, whereas when the temperature of the first electrolyte is 80° C., the ZUR value is greatly increased to about 87%.

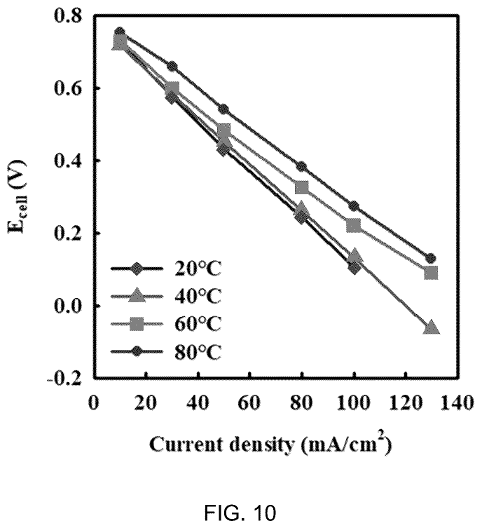

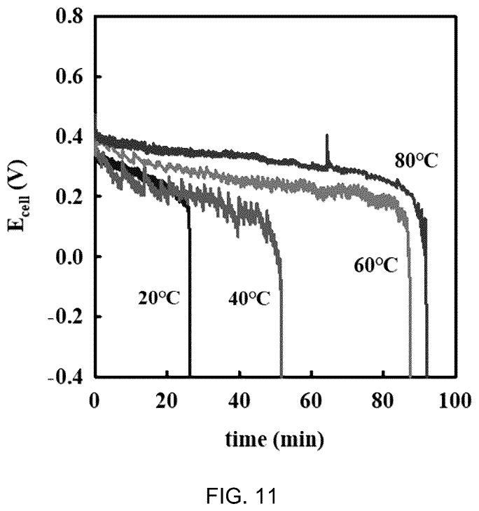

FIG. 10 shows a discharge graph depending on the current density of the metal-aqueous battery at different temperatures of the first electrolyte. FIG. 11 shows a discharge graph with time of the metal-aqueous battery at different temperatures of the first electrolyte. As the temperature of the electrolyte was raised, both operating performance and duration were improved.

### TEST EXAMPLE 3

The metal-aqueous battery having a double cell DC structure as shown in FIG. 1 operated at different temperatures of the second electrolyte, such as 20° C., 40° C., 60° C., and 80° C.

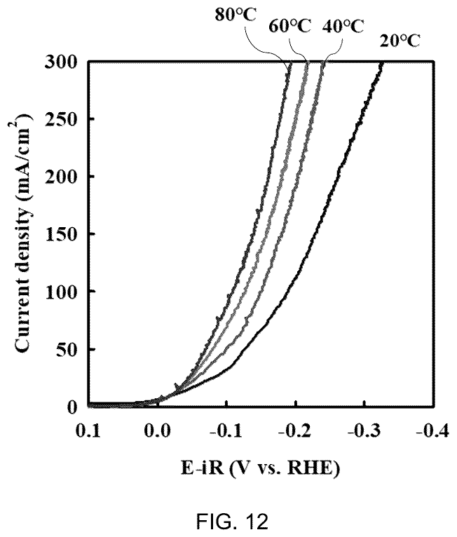

FIG. 12 shows results of evaluation of the metal-aqueous battery at different temperatures of the second electrolyte. As the temperature of the second electrolyte was raised, overvoltage of the electrode decreased. Specifically, when the temperature of the second electrolyte was raised from 20° C. to 40° C., or from 40° C. to 80° C., overvoltage was about 0.05 V, confirming decreased resistance of the battery.

### TEST EXAMPLE 4

The metal-aqueous battery having a double cell DC structure as shown in FIG. 1 operated under the following conditions.
Condition 1: first electrolyte temperature 20° C., second electrolyte temperature 20° C.
Condition 2: first electrolyte temperature 80° C., second electrolyte temperature 20° C.
Condition 3: first electrolyte temperature 80° C., second electrolyte temperature 80° C.

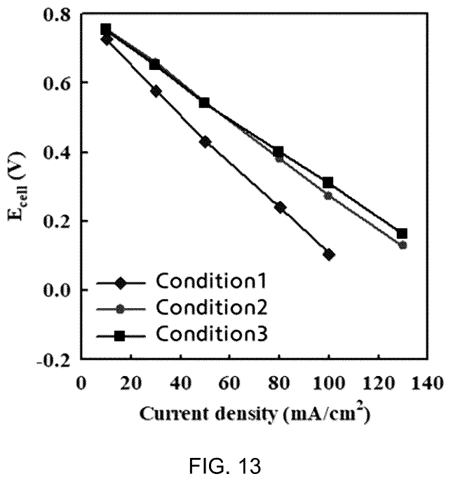

FIG. 13 shows a discharge graph of the metal-aqueous battery operated under Conditions 1 to 3. Conditions 2 and 3 showed similar cell performance. It can be found that the temperature of the first electrolyte, rather than the temperature of the second electrolyte, has a greater effect on changes in performance depending on an increase in the temperature of the electrolyte.

As is apparent from the above description, according to the present disclosure, a metal-aqueous battery with improved current generation amount and current generation rate can be obtained.

According to the present disclosure, a metal-aqueous battery capable of preventing the anode from being passivated can be obtained.

As the test examples and embodiments of the present disclosure have been described in detail above, the scope of the present disclosure is not limited to the above-described test examples and embodiments, and various modifications and improvements made by those skilled in the art using the basic concept of the present disclosure defined in the following claims are also within the scope of the present disclosure.

What is claimed is;:

1. A metal-aqueous battery, comprising:
a double cell comprising:
a pair of single cells, each of the single cells comprising:
an anode,
a cathode,
a separator interposed between the anode and the cathode, and
a cathode spacer interposed between the separator and the cathode and configured to form a gap between the separator and the cathode; and
a current collector interposed between the pair of single cells such that cathodes of the single cells face each other across the current collector.

2. The metal-aqueous battery of claim 1, wherein:
each of the single cells further comprises a plate in a sheet form at a predetermined thickness comprising a first main surface and a second main surface facing the first main surface, disposed on an outer surface of the single cell, and having an inner space open toward the first main surface,
the anode is accommodated in the inner space, and
the separator is stacked on the first main surface to cover an open surface of the inner space.

3. The metal-aqueous battery of claim 2, wherein the plate comprises:
a first electrolyte inlet formed in a portion of a side surface and configured to communicate with the inner space; and
a first electrolyte outlet formed at a position spaced apart from the first electrolyte inlet by a predetermined distance and configured to communicate with the inner space.

4. The metal-aqueous battery of claim 2, wherein:
the anode is in a form of a pellet,
each of the single cells further comprises a support that is obliquely provided in the inner space and comprises a plurality of through-holes,
the anode is accommodated between an inner surface of the plate and the support, and
a diameter of the through-holes is smaller than a diameter of the anode.

5. The metal-aqueous battery of claim 2, wherein:
the anode is in a form of a sheet, and
each of the single cells further comprises a pressing part that is accommodated in the inner space and is provided between an inner surface of the plate and the anode to apply a pressing force to move the anode toward the separator.

6. The metal-aqueous battery of claim 1, wherein the anode comprises at least one selected from the group consisting of lithium (Li), sodium (Na), magnesium (Mg), zinc (Zn), aluminum (Al), and a combination thereof.

7. The metal-aqueous battery of claim 1, further comprising a wire configured to electrically connect the anode and the current collector to each other.

8. The metal-aqueous battery of claim 1, wherein the cathode comprises a noble metal catalyst loaded on a carrier.

9. The metal-aqueous battery of claim 2, further comprising a separator spacer interposed between the plate and the separator, having a predetermined thickness, and having a frame shape, a central portion of which is open, wherein the separator spacer supports an edge of the separator to expand the inner space of the plate by a thickness of the separator spacer.

10. The metal-aqueous battery of claim 2, further comprising a protective layer, which has a shape corresponding to the open surface of the plate, is provided to the open surface of the plate, and is porous.

11. The metal-aqueous battery of claim 1, wherein the separator comprises a material having cation conductivity or a material having anion conductivity.

12. The metal-aqueous battery of claim 1, wherein:
the cathode spacer has a frame shape, a central portion of which is open, and supports an edge of the separator to form the gap, and
the cathode spacer comprises a second electrolyte inlet formed in a portion of a side surface of the cathode spacer and configured to communicate with the gap and a second electrolyte outlet formed in a portion of a side surface of the cathode spacer spaced apart from the second electrolyte inlet by a predetermined distance and configured to communicate with the gap.

13. The metal-aqueous battery of claim 2, further comprising:
a first electrolyte accommodated in the inner space of the plate; and
a second electrolyte accommodated in the gap.

14. The metal-aqueous battery of claim 13, wherein the first electrolyte comprises an alkali metal hydride.

15. The metal-aqueous battery of claim 13, wherein the second electrolyte comprises protons and bicarbonate ions.

16. The metal-aqueous battery of claim 13, wherein a temperature of the first electrolyte is about 40° C. to about 80° C., or a temperature of the second electrolyte is about 40° C. to about 80° C.

17. The metal-aqueous battery of claim 13, wherein a temperature of the first electrolyte is equal to or higher than a temperature of the second electrolyte.

18. The metal-aqueous battery of claim 1, comprising a stack configured such that a plurality of the double cells is stacked.

19. A hydrogen generation and carbon dioxide storage system, comprising:
the metal-aqueous battery of claim 1;
a first electrolyte supply unit configured to supply a first electrolyte to the metal-aqueous battery; and
a second electrolyte supply unit configured to supply a second electrolyte to the metal-aqueous battery.

20. The hydrogen generation and carbon dioxide storage system of claim 19, further comprising a first heating apparatus disposed between the metal-aqueous battery and the first electrolyte supply unit; and a second heating apparatus disposed between the metal-aqueous battery and the second electrolyte supply unit.
